(19) United States
(12) Patent Application Publication
(10) Pub. No.: US 2026/0196604 A1
(43) Pub. Date: Jul. 9, 2026

(54) IMMERSION COOLING MODULE

(71) Applicants: SK INNOVATION CO., LTD., Seoul (KR); SK On Co., Ltd., Seoul (KR)

(72) Inventors: In Sik JUNG, Daejeon (KR); Gi Hong MIN, Daejeon (KR)

(21) Appl. No.: 19/438,632

(22) Filed: Jan. 1, 2026

(30) Foreign Application Priority Data
Jan. 6, 2025 (KR) 10-2025-0001759

(51) Int. Cl. H01M 10/6568; H01M 10/48; H01M 10/613; H01M 10/63

(52) U.S. Cl. CPC H01M 10/6568; H01M 10/486; H01M 10/613; H01M 10/63

(57) ABSTRACT

An immersion cooling module includes a housing containing a cooling fluid and at least one battery cell immersed therein. The housing features first and second end inlets at opposite sides. A connection pipe is coupled below the housing, extending between the inlets. A plurality of cooling spaces, divided by the battery cell, communicate with the connection pipe through connection conduits formed on a lower surface of the housing. The module further includes a heat exchanger coupled to the connection pipe and having a cooling fluid outlet. A fluid pump is coupled to the connection pipe to control a flow direction of the cooling fluid toward the first and second sides of the heat exchanger, facilitating efficient thermal management of the battery cell.

### CROSS REFERENCE TO RELATED APPLICATION

The present application claims priority to Korean Patent Application No. 10-2025-0001759, filed on January 6, 2025, the entire contents of which are incorporated by reference herein.

### BACKGROUND

### Technical Field

The embodiments of the present disclosure relate to an immersion cooling module.

### Description of the Related Art

In recent years, as mobile devices such as mobile phones and laptops have become smaller and lighter, and electric vehicles and hybrid vehicles demand high-capacity power sources, a variety of batteries are being developed and used.

In the case of secondary batteries, efficiency is becoming increasingly important depending on the application field, but problems such as heat generation and fires during charging or operation occur due to external factors.

Accordingly, technologies are being developed to increase the operating efficiency of secondary batteries and ensure safety. Moreover, a recent surge in electricity usage has led to increased carbon emissions and exacerbated global warming concerns, which has called for more efficient device operation mechanisms, and improved cooling methods and maximization of cooling efficiency therefor.

### SUMMARY

According to an embodiment of the present disclosure, provided is an immersion cooling module that maximizes battery cell cooling efficiency by optimizing the performance of the entire cooling fluid contained within a housing, wherein the cooling efficiency of a cooling fluid in each cooling space is enhanced according to the spatial arrangement of battery cells.

In addition, provided is an immersion cooling module that increases cooling efficiency by cooling battery cells through the vaporization of a cooling fluid within a sealed housing, wherein the gas (vapor) is collected, condensed into liquid form, and recirculated to continuously cool the battery cells.

In order to achieve the above objectives, according to an embodiment of the present disclosure, there is provided an immersion cooling module including a housing configured to contain a cooling fluid at a predetermined level and have a first end inlet and a second end inlet at opposite sides, respectively; at least one battery cell immersed in the cooling fluid; a connection pipe separately coupled below the housing, extending from the first end inlet to the second end inlet; a connection conduit formed on a lower surface of the housing for each of a plurality of cooling spaces, with the cooling spaces being divided by the battery cell, so that the cooling fluid flows between the cooling spaces and the connection pipe; a heat exchanger coupled to the connection pipe and having a cooling fluid outlet formed therein; and a fluid pump coupled to the connection pipe and connected to each of a first side and a second side of the heat exchanger to control a flow direction of the cooling fluid toward the first side and the second side of the heat exchanger.

In this case, the fluid pump may include a first fluid pump coupled to the connection pipe on the first side of the heat exchanger; and a second fluid pump coupled to the connection pipe on the second side of the heat exchanger.

In addition, the heat exchanger may include a temperature sensor configured to measure the temperature of a cooling fluid inside the heat exchanger; the outlet through which the cooling fluid flows out; and a discharge pump configured to control an amount of the cooling fluid exiting the outlet according to the temperature sensor.

In addition, the connection conduit may include a damper configured to regulate an inflow and outflow of a cooling fluid between individual cooling spaces divided by the battery cell and the connection pipe.

In addition, the module may further include a porous moisture absorption member bonded to a surface of the battery cell that contacts the cooling fluid, and a condenser coupled to a pipe connected to an outside of the housing so that gas flows to and from a first side and a second side of an upper space inside the housing.

In addition, the porous moisture absorption member may have one or more through-holes.

In addition, the heat exchanger may be configured such that a cooling fluid entering the heat exchanger is mixed and undergoes heat exchange.

According to another embodiment of the present disclosure, there is provided an immersion cooling module including a housing configured to contain a cooling fluid; at least two battery cells at least partially immersed in the cooling fluid and spaced apart from each other and from side walls of the housing to form a plurality of cooling spaces inside the housing; a fluid circulation path bypassing an interior of the housing and configured to allow the cooling fluid to flow from or to each of the plurality of cooling spaces of the housing into a heat exchanger; a temperature sensor configured to measure a temperature of the cooling fluid inside the heat exchanger; and a discharge pump configured to discharge a portion of the cooling fluid from the heat exchanger when the measured temperature exceeds a predetermined threshold.

The features and advantages of the embodiments of the present disclosure will become more apparent from the following detailed description based on the accompanying drawings.

Terms or words used in the present disclosure and claims should not be construed in their usual, dictionary meaning, and should be interpreted with meaning and concept consistent with the technical idea of the present disclosure based on the principle that an inventor can define terminology appropriately to describe his or her invention in the best way possible.

According to an embodiment of the present disclosure, by maintaining uniform cooling performance of a cooling fluid within the immersion cooling module, the stable operating performance of battery cells can be ensured.

Furthermore, by maximizing the cooling efficiency of a cooling fluid contained within the housing, the cooling performance of the cooling fluid can be fully utilized.

Furthermore, by increasing the cooling efficiency of battery cells or battery cell modules within the immersion cooling module, energy usage efficiency can be improved, thereby effectively reducing carbon emissions.

### BRIEF DESCRIPTION OF THE DRAWINGS

The above and other objectives, features, and other advantages of the embodiments of the present disclosure will be more clearly understood from the following detailed description when taken in conjunction with the accompanying drawings, in which:

FIG. 1 is a schematic view of an immersion cooling module according to an embodiment of the present disclosure;

FIG. 2 is a schematic view of a modified immersion cooling module according to an embodiment of the present disclosure;

FIG. 3 is a plan view of a porous moisture absorption member according to an embodiment of the present disclosure; and

FIG. 4 is a schematic view of the operation of a heat exchanger of an immersion cooling module according to still another embodiment of the present disclosure.

### DETAILED DESCRIPTION

Terms used to describe the embodiments of the present disclosure are not intended to limit this disclosure. It should be noted that singular expressions include plural expressions unless the context clearly dictates otherwise.

It should be noted that, in assigning reference numerals to components in the drawings, identical components are assigned the same reference numerals as much as possible even if they are shown in different drawings, and similar reference numbers are assigned to similar components.

The drawings may be schematic or exaggerated for the purpose of illustrating the embodiments. In this document, expressions such as “have”, “may have”, “include”, or “may include” refer to the presence of the corresponding feature (e.g., a numerical value, function, operation, or component such as a part), and do not exclude the presence of additional features.

Terms such as “one”, “other”, “another”, “first”, “second”, etc., are used to distinguish one component from another component, and the components are not limited by the terms.

Hereinafter, the embodiments of the present disclosure will be described in detail with reference to the attached drawings.

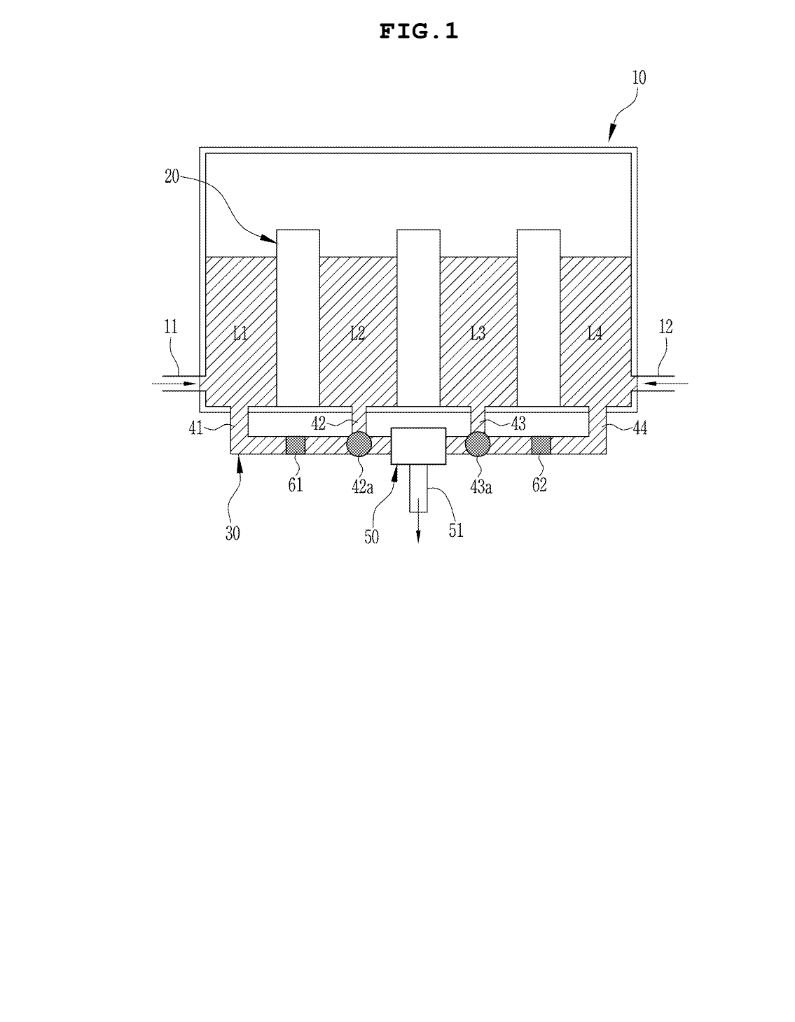

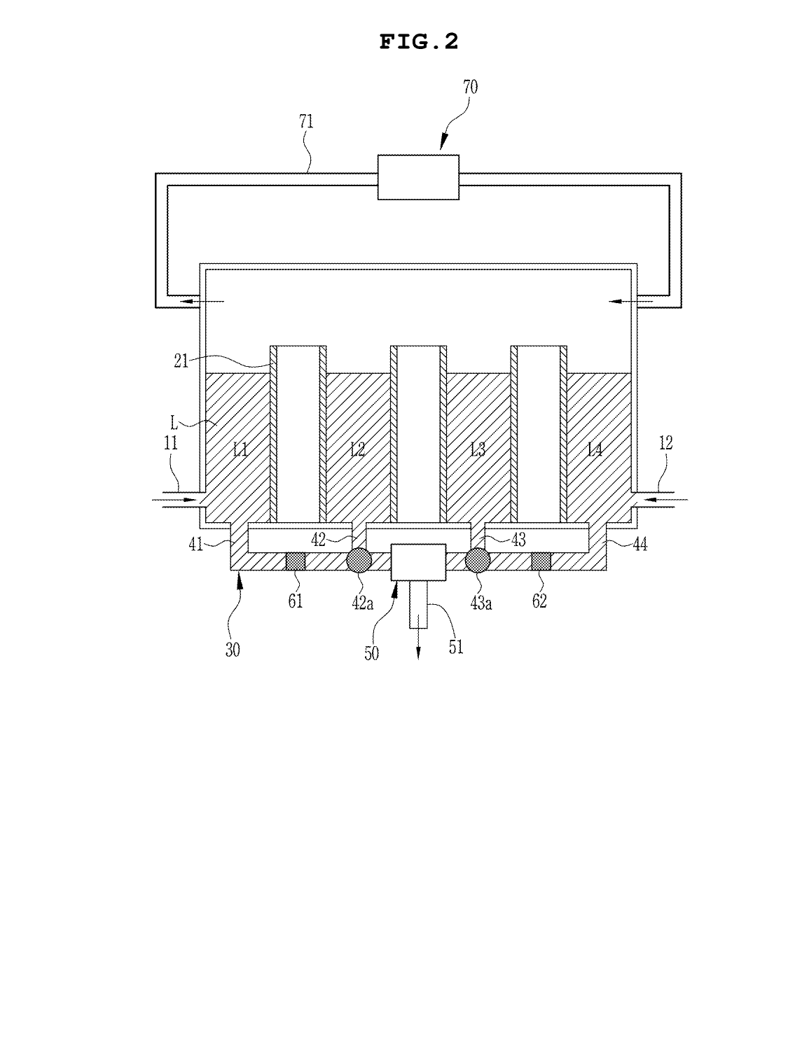

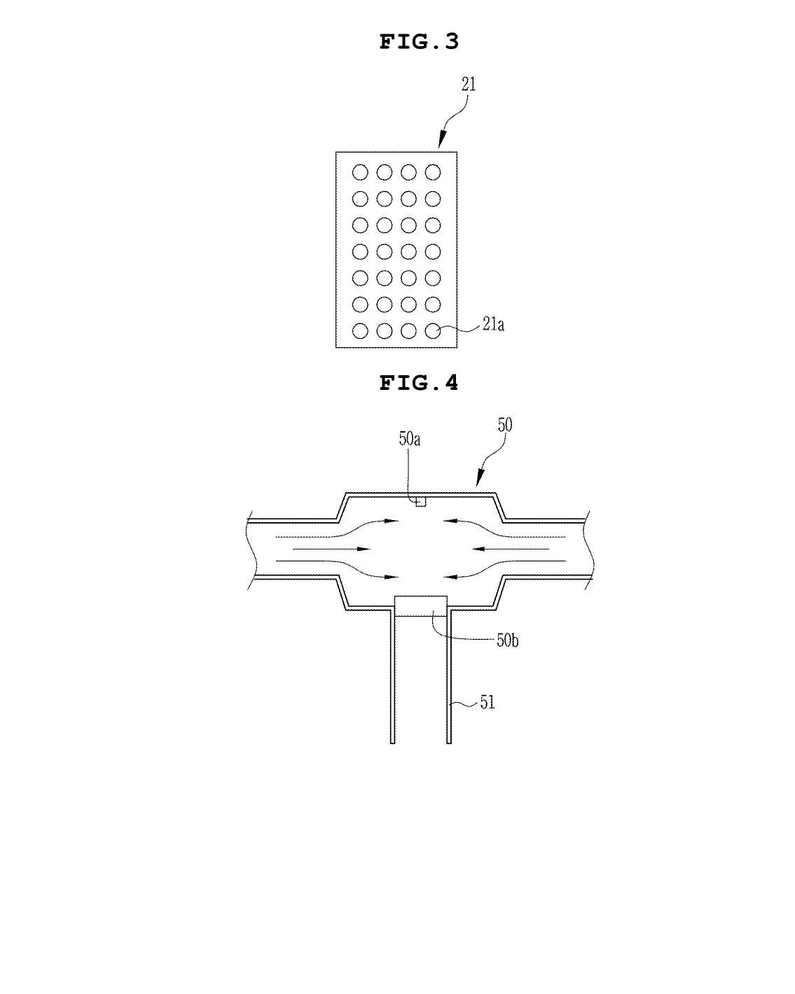

FIG. 1 is a schematic view of an immersion cooling module according to an embodiment of the present disclosure; FIG. 2 is a schematic view of a modified immersion cooling module according to an embodiment of the present disclosure; FIG. 3 is a plan view of a porous moisture absorption member according to an embodiment of the present disclosure; and FIG. 4 is a schematic view of the operation of a heat exchanger of an immersion cooling module according to still another embodiment of the present disclosure.

Referring to FIG. 1, an immersion cooling module according to an embodiment of the present disclosure may include a housing 10 containing a cooling fluid at a predetermined level, and having a first end inlet 11 and a second end inlet 12 respectively at opposite sides of the housing 10; at least one battery cell 20 immersed in the cooling fluid; a connection pipe 30 that is separately connected to a bottom surface of the housing 10 and extends between a region near the first end inlet 11 and a region near the second end inlet 12; a connection conduit formed on the lower surface of the housing 10 for each of a plurality of cooling spaces, with the cooling spaces being divided by the battery cells 20, so that the cooling fluid flows between the cooling spaces and the connection pipe 30; a heat exchanger 50 coupled to the connection pipe 30 and having a cooling fluid outlet 51 formed therein; and fluid pumps 61, 62 coupled to the connection pipe 30 and respectively connected to one side and the other side of the heat exchanger 50 to control the flow direction of the cooling fluid toward one side and the other side of the heat exchanger 50.

In the immersion cooling module according to an embodiment of the present disclosure, when the cooling fluids are introduced into the housing 10 through the inlets 11 and 12 on opposite sides thereof, the cooling fluids accommodated in the connection pipe 30 coupled below the housing 10 are mixed with each other through the heat exchanger 50, and then the mixed cooling fluid circulates throughout the entire interior of the housing 10, thereby maximizing the cooling performance of the cooling fluid. In addition to maximizing the cooling performance of the cooling fluid, in case that the cooling efficiency of the cooling fluid falls below a critical value, the existing cooling fluid may be discharged to the outside and new cooling fluid may be reintroduced through the inlets 11 and 12 on opposite sides of the housing 10.

As shown in FIG. 1, the housing 10 may accommodate a cooling fluid at a predetermined level. The cooling fluid may be contained in the housing 10 at a level that leaves a predetermined space in the upper portion of the interior of the housing 10. In addition, as shown in FIG. 2, the space inside the housing 10 may be formed such that a cooling gas formed by vaporization of the cooling fluid fills the upper space of the interior of the housing 10 during the process of cooling the battery cells 20 with the cooling fluid. Due to this, the gas filled in the upper space inside the housing 10 may be liquefied through an external condenser 70 and reintroduced into the housing 10 as illustrated in FIG. 2.

The housing 10 accommodates a cooling fluid inside, and the first end inlet 11 and the second end inlet 12 may be formed at one end and the other end of the housing 10, respectively. Cooling fluid may be introduced from each end of the housing 10.

A plurality of battery cells 20 may be disposed inside the housing 10 spaced apart from each other, and immersed at least partially inside the cooling fluid. As shown in FIG. 1, the battery cells 20 may be arranged at predetermined intervals, and the intervals may be formed as intervals between battery cells 20 or as intervals between battery cell 20 modules.

Below the housing 10, the connection pipe 30 may be provided to allow the cooling fluid contained within the housing 10 to flow outside the housing 10, while being separated from the interior of the housing 10. The two ends of the connection pipe 30 are connected in the direction of the first end inlet 11 side and the second end inlet 12 side of the housing 10, so that at least part of the cooling fluid that is introduced through the first end inlet 11 into the first cooling space L1 may flow directly into the connection pipe 30, or a cooling fluid flowing through the second end inlet 12 into the fourth cooling space L4 may flow directly into the connection pipe 30.

As the battery cells 20 or battery cell modules are arranged at a predetermined interval inside the housing 10, the connection conduit may be provided on the lower surface of the housing 10 for each cooling space so as to be connected to the connection pipe 30 to allow the cooling fluid inside the connection pipe 30 to flow into and out of the cooling space created by the battery cells 20 or battery cell modules being spaced apart.

The connection conduit may be coupled in a manner that allows a cooling fluid to flow through the connection pipe 30 and the cooling space inside the housing 10. By doing so, the cooling fluid flowing in the connection pipe 30 may flow into and out of the cooling space between the battery cells 20 or battery cell modules.

As shown in FIG. 1, a first connection conduit 41 connected to the connection pipe 30 from the lower surface of the housing 10 for a first cooling space L1 on the first end inlet 11 side, as well as a second connection conduit 42 and a third connection conduit 43 connected to the connection pipe 30 from the lower surface of the housing 10 for a second cooling space L2 and a third cooling space L3 created between the battery cells 20 may be individually coupled to be connected to the connection pipe 30. Finally, a fourth connection conduit 44 connected to the connection pipe 30 from the lower surface of the housing 10 for a fourth cooling space L4 created by the battery cell 20 and the inner surface of the housing 10 may be coupled.

In an embodiment of the present disclosure, the first cooling space L1, the second cooling space L2, the third cooling space L3, and the fourth cooling space L4 represent cooling spaces which are partitioned, and there is no limitation on the number of partitioned cooling spaces, and at least one cooling space may be formed according to the arrangement of various battery cells 20 or battery cell modules. Each cooling space formed in this way and the connection pipe 30 may be mutually connected so that a cooling fluid can flow therebetween. Hence, the cooling spaces formed inside the housing between the spaced apart battery cells and also between the first battery cell and the side wall of the housing 10 and also between the last battery cell and the side wall of the housing 10 may each be fluidly connected with the connection pipe 30 through respective connection conduits 41, 42, 43, and 44.

The heat exchanger 50 is connected to the connection pipe 30 and may maximize the cooling efficiency of the entire cooling fluid contained within the housing 10 via heat exchange between cooling fluids flowing through the connection pipe 30 on both sides of the heat exchanger 50.

The first end inlet 11 and the second end inlet 12 are respectively formed at one end and the other end in the housing 10, and the outlet 51 for discharging the cooling fluid may be formed in the heat exchanger 50.

Referring to FIG. 4, the temperature of the cooling fluids that are mixed through the heat exchanger 50 may be measured by means of a temperature sensor 50a, and in case that the temperature of the mixed cooling fluid exceeds a preset temperature during the mixing and redistribution process of the cooling fluid, the high temperature cooling fluid may be discharged and new cooling fluid may be introduced through the first end inlet 11 and the second side inlet 12 of the housing 10.

According to an embodiment of the present disclosure, in the process of cooling battery cells 20 with a cooling fluid contained within the housing 10, by alleviating differences in the temperature and cooling performance of the cooling fluid caused by variations in heat generation at different locations of the battery cells 20, the overall efficiency of battery cell cooling by the cooling fluid contained within the housing 10 may be increased.

The fluid pump is connected to the connection pipe 30 through which cooling fluid is introduced into the heat exchanger 50, and is coupled to one side and to the other side of the heat exchanger 50 to introduce cooling fluid into the heat exchanger 50 or to re-introduce cooling fluid cooled from the heat exchanger 50 into the housing 10 through the connection conduit.

As shown in FIG. 1, a first fluid pump 61 may be coupled to the connection pipe 30 on one side of the heat exchanger 50, and a second fluid pump 62 may be coupled to the connection pipe 30 on the other side of the heat exchanger 50. The number of fluid pumps and their installation arrangements may be adjusted and applied in various ways, taking into consideration the interior size of the housing 10, the amount of cooling fluid contained within the housing 10, etc.

As shown in FIG. 2, the immersion cooling module according to an embodiment of the present disclosure may further include a porous moisture absorption member 21 bonded to a surface of the battery cell 20 that contacts the cooling fluid, and also the condenser 70 coupled to a pipe 71 connected to the outside of the housing 10 so that gas flows to and from one side and the other side of the upper space inside the housing 10.

The porous moisture absorption member 21 is impregnated with the cooling fluid to cool battery cells 20 and at the same time, the cooling effect on battery cells 20 may be increased by the latent heat absorbed when promoting vaporization of the cooling fluid impregnated in the porous moisture absorption member 21 through the heat generation from the battery cells 20.

In addition, vaporization of the cooling fluid is induced by using the porous moisture absorption member 21, and the vaporized gas may be filled in a predetermined space in the upper portion of the interior of the housing 10.

When the vaporized cooling fluid is supplied to the upper space inside the housing 10, the gas (vapor) passes through the condenser 70 that is connected to the pipe 71 through the pipe 71 provided to allow gas to circulate to one side and the other side of the interior space of the housing 10, so that the liquefied cooling fluid is reintroduced into the housing 10.

As shown in FIG. 3, the porous moisture absorption member 21 may have one or more through-holes 21a so that cooling efficiency by a cooling fluid in direct contact with a battery cell 20 may be achieved, as well as cooling by the latent heat of vaporization of the cooling fluid impregnated in the porous moisture absorption member 21.

As shown in FIG. 4, the heat exchanger 50 may include the temperature sensor 50a that measures the temperature of a cooling fluid inside the heat exchanger 50, the outlet 51 through which a cooling fluid flows out, and a discharge pump 50b that controls the amount of the cooling fluid that is exiting the outlet 51 according to the temperature sensor 50a.

As previously described, heat exchange between cooling fluids may be achieved inside the heat exchanger 50 by mixing cooling fluids flowing in from opposite sides of the heat exchanger 50.

That is, as shown in FIG. 1, the temperature of each of the first cooling space L1, the second cooling space L2, the third cooling space L3, and the fourth cooling space L4 is measured by a temperature sensor (not shown), and the flow direction of the cooling fluid in the connection pipe 30 may be controlled according to the temperature difference.

For example, in case that the temperature of a cooling fluid in the third cooling space L3 increases rapidly, the cooling fluid is discharged to the connection pipe 30 through the third connection conduit 43 and supplied toward the heat exchanger 50 by means of the second fluid pump 62, so that a relatively low temperature cooling fluid from the first cooling space L1 or the second cooling space L2 may be introduced into the heat exchanger 50 by means of the first fluid pump 61 to allow the cooling fluids to exchange heat with each other.

In this case, the cooling fluids are mixed within the heat exchanger 50 to allow a cooling fluid at a lower temperature to be reintroduced into the third cooling space L3.

Although the cooling temperature of a cooling fluid may be controlled by mixing cooling fluids inside the heat exchanger 50, if the temperature of the cooling fluid exceeds a preset temperature even after heat exchange between the cooling fluids, the cooling performance may fall below the standard. Thus, the discharge pump 50b in the heat exchanger 50 is driven to discharge a certain amount of cooling fluid through the outlet 51.

Hence, for example, if the cooling fluid in the cooling space L3 gets too hot, it is sent to the heat exchanger 50 using the described pumps and conduits. At the same time, cooler fluid from the cooling spaces L1 or L2 is also sent into the heat exchanger 50, so the fluids can mix and exchange heat. This mixing lowers the temperature, and the cooled fluid is then returned to the cooling space L3. However, if the fluid temperature is still above the preset limit even after mixing, the cooling system’s performance drops below a predetermined threshold, and in that case, the discharge pump 50b disposed inside the heat exchanger 50 expels some fluid through the outlet 51 and new cooling fluid is injected into the housing 10 to maintain proper cooling .

More specifically, in this case, when a certain amount of cooling fluid is discharged, by controlling the inflow of new cooling fluid introduced through the first end inlet 11 and the second end inlet 12 of the housing 10, the level of cooling fluid contained within the housing 10 may be appropriately maintained.

Accordingly, as shown in FIGS. 1 and 2, in order to allow a cooling fluid flowing from the connection pipe 30 to flow into each cooling space or to allow a cooling fluid from each cooling space to flow out into the connection pipe 30, dampers 42a and 43a that can control the flow direction of cooling fluid may be coupled to the first connection conduit 41, the second connection conduit 42, the third connection conduit 43, and the fourth connection conduit 44 formed on the lower surface of the housing 10 corresponding to the first cooling space L1, the second cooling space L2, the third cooling space L3 and the fourth cooling space L4.

The dampers 42a and 43a may control the inflow and outflow of cooling fluid between individual cooling spaces divided by the battery cells 20 and the connection pipe 30. In addition, the dampers 42a and 43a are coupled between the connection pipe 30 and the connection conduits to regulate and change the direction of the flow of a cooling fluid by opening and closing the connection conduits.

To be specific, the damper is connected to the intersection of the connection pipe 30 and the connection conduit to regulate the flow amount or flow direction of a cooling fluid by controlling the opening angle of an adjustment member (not shown) having the same shape as the cross-section of the inside of the pipe (conduit).

That is, the damper's adjustment member may block the inlet of the connection conduit to prevent a cooling fluid inside the connection pipe from flowing into the cooling space through the connection conduit. In addition, by adjusting the forward inclination of the adjustment member, some of the cooling fluid inside the connection pipe may flow through the connection pipe, and the remaining part may flow into the cooling space through the connection conduit.

In this case, the adjustment member may be formed with an area corresponding to the internal cross-sectional area of the connection pipe 30, and may regulate the opening and closing of the passage or the amount of cooling fluid flowing into the cooling space by controlling the opening degree of the cross-section of the pipe or conduit through which the cooling fluid flows.

The damper may regulate the flow direction of a cooling fluid entering or leaving the heat exchanger 50 as the first fluid pump 61 and the second fluid pump 62 operate, thereby selectively supplying or discharging the required cooling fluid to each cooling space.

As described above, by sensing the temperature of a cooling fluid in each cooling space, the cooling fluid with the highest temperature is discharged toward the heat exchanger 50, where the cooling fluid is mixed with the cooling fluid of a relatively lower temperature. The mixed cooling fluid, having a reduced temperature, is then reintroduced into the cooling space through a circulation process, thereby maximizing the overall cooling efficiency by the entire cooling fluid contained within the housing 10.

As shown in FIGS. 1 and 2, since the first connection conduit 41 and the fourth connection conduit 44 may allow initial cooling fluids flowing in from the first end inlet 11 and the second end inlet 12 to flow into the connection pipe 30, the cooling performance of the entire cooling fluid inside the housing 10 may be maintained through heat exchange with cooling fluids in the remaining cooling spaces.

The embodiments of the present disclosure have been described in detail through specific embodiments and are only illustrative and do not limit the scope of the appended claims. It should be apparent to those skilled in the art that various changes and modifications to the embodiments are possible within the scope and technical idea of the present disclosure, and such changes and modifications fall within the scope of the appended claims. Furthermore, the embodiments maybe combined to form additional embodiments.

What is claimed is:

1. An immersion cooling module comprising:
a housing configured to contain a cooling fluid at a predetermined level and have a first end inlet and a second end inlet at opposite sides, respectively;
at least one battery cell immersed in the cooling fluid;
a connection pipe separately coupled below the housing, extending from the first end inlet to the second end inlet;
a connection conduit formed on a lower surface of the housing for each of a plurality of cooling spaces defined by the at least one battery cell, so that the cooling fluid flows between the cooling spaces and the connection pipe;
a heat exchanger coupled to the connection pipe and having a cooling fluid outlet formed therein; and
a fluid pump coupled to the connection pipe and connected to each of a first side and a second side of the heat exchanger to control a flow direction of the cooling fluid toward the first side and the second side of the heat exchanger.

2. The module of claim 1, wherein the fluid pump comprises:
a first fluid pump coupled to the connection pipe on the first side of the heat exchanger; and
a second fluid pump coupled to the connection pipe on the second side of the heat exchanger.

3. The module of claim 1, wherein the heat exchanger comprises:
a temperature sensor configured to measure the temperature of a cooling fluid inside the heat exchanger;
the outlet through which the cooling fluid flows out; and
a discharge pump configured to control an amount of the cooling fluid exiting the outlet according to the temperature sensor.

4. The module of claim 1, wherein the connection conduit comprises:
a damper configured to regulate an inflow and outflow of a cooling fluid between individual cooling spaces divided by the battery cell(s) and the connection pipe.

5. The module of claim 1, further comprising:
a porous moisture absorption member bonded to a surface of the battery cell that contacts the cooling fluid; and
a condenser coupled to a pipe connected to an outside of the housing so that gas flows to and from a first side and a second side of an upper space inside the housing.

6. The module of claim 5, wherein the porous moisture absorption member has one or more through-holes.

7. The module of claim 3, wherein the heat exchanger is configured such that a cooling fluid entering the heat exchanger is mixed and undergoes heat exchange.

8. An immersion cooling module comprising:
a housing configured to contain a cooling fluid;
at least two battery cells immersed in the cooling fluid at least partially, and spaced apart from each other and from the side walls of the housing to form a plurality of cooling spaces inside the housing;
a fluid circulation path bypassing the interior of the housing and configured to allow the cooling fluid to flow from or to each of the plurality of the cooling spaces of the housing into a heat exchanger;
a temperature sensor configured to measure the temperature of the cooling fluid inside the heat exchanger; and
a discharge pump configured to discharge a portion of the cooling fluid from the heat exchanger when the measured temperature exceeds a predetermined threshold.
